(19) United States
(12) Patent Application Publication
(10) Pub. No.: US 2009/0041127 A1
(43) Pub. Date: Feb. 12, 2009

(54) FLEXIBLE LENGTH DECODER

(75) Inventors: Po-Ting Lin, Tainan County (TW); Shih-Ta Hsu, Tainan County (TW)

Correspondence Address: J C PATENTS, INC., 4 VENTURE, SUITE 250, IRVINE, CA, 92618, US

(73) Assignee: HIMAX TECHNOLOGIES LIMITED, Tainan County (TW)

(21) Appl. No.: 11/854,332

(22) Filed: Sep. 12, 2007

(30) Foreign Application Priority Data
Aug. 7, 2007 (TW) 96128997

(51) Int. Cl. H04N 7/26

(52) U.S. Cl. 375/240.23; 375/E07.026

(57) ABSTRACT

A flexible length decoder including a plurality of data filter units and a control unit is provided. The data filter units perform a comparing operation on a data stream according its corresponding pattern and output a comparing result. The control unit controls the configurations of the data filter units. If the space of any one of the data filter units for storing the pattern is not enough to record the required pattern, the control unit combines two or more data filter units into an equivalent data filter unit, such that the equivalent data filter unit stores the pattern and performs the comparing operation.

### CROSS-REFERENCE TO RELATED APPLICATION

This application claims the priority benefit of Taiwan application serial no. 96128997, filed on Aug. 7, 2007. All disclosure of the Taiwan application is incorporated herein by reference.

### BACKGROUND OF THE INVENTION

1. Field of the Invention

The present invention relates to a decoder. More particularly, the present invention relates to a flexible length decoder that can dynamically adjust the length of filtering data according to the required pattern.

2. Description of Related Art

With the development of the multimedia technology, compared with conventional televisions, digital televisions (DTVs) are capable of providing sharp image quality and preferred surround sound. Moreover, the DTVs utilize digital signal transport and compression, so they can effectively utilize the bandwidth and reduce the noise interference from outside. During the process of digital signals, the MPEG-2 encoding standard defines two forms of data stream, namely, program stream (PS) and transport stream (TS).

FIG. 1A is a schematic view of a PS. Referring to FIG. 1A, a PS 100 is composed of one or more streams (for example, streams 110, 120) containing packetized elementary stream (PES) packets, and the PES packets make reference to a common time base. For example, a stream 120 includes video PES packets 122-124, an audio PES packet 125, and a data PES packet 126, as well a header 121. The PS is deigned to be used in the transport in an error-free environment and is applicable to the application of interactive multimedia. The elementary stream (ES) is audio, video, and a single signal (generally, a compressed signal) output by a data encoder, which becomes PES after being packetized.

FIG. 1B is a schematic view of TS. Referring to FIG. 1B, a TS 130 is composed of transport packets of one or more programs, in which the PES packets are scattered into fixed-sized transport packets. For example, the TS 130 includes a video transport packet 131, an audio transport packet 132, a private data transport packet 133, a service information transport packet 134 and a null transport packet 135, and so on. Each of the transport packets has a header on the front end. The PES packet composed of the elementary streams constituting a program make reference to a common time base, so the transport packets in the TS can make reference to different time bases.

The data streams in the form of PS and TS are established by a multiplexer defined by MPEG-2, so a de-multiplexer is required to be correspondingly designed on a receiving end to separate the packets and store the packets into corresponding memory blocks. FIG. 2 is a view of an architecture of a de-multiplexer. Referring to FIG. 2, a de-multiplexer 200 includes a plurality of data filters 210.

When the data stream is transported to the de-multiplexer 200, each specific data fragment in the data stream needs to be processed by a corresponding data filter 210. In short, a specific pattern is stored in each data filter 210, and the data filter 210 compares the data fragments with the pattern stored therein to filter desired information. However, the data filter 210 generally has a fixed length, for example, n-bytes, so the data filter 210 can merely compare the patterns with fixed length. If desired information is required to be compared more accurately, additional subsequent processes are required, which will cause additional waste of the bandwidth.

### SUMMARY OF THE INVENTION

The present invention is directed to a decoder, which can dynamically adjust the length of filtering data according to the required pattern and accurately compare data fragments to filter desired information.

The present invention is further directed to an operation method of a decoder, which also has the above advantages.

The present invention provides a decoder including a plurality of data filter units and a control unit. The data filter units perform a comparing operation on a data stream according its corresponding pattern and output a comparing result. The control unit controls the configurations of the data filter units. If the space of any one of the data filter units for storing the pattern is not enough to record the required pattern, the control unit combines two or more of the data filter units into an equivalent data filter unit, such that the equivalent data filter unit stores the required pattern to perform the comparing operation.

The present invention also provides an operation method of a decoder. First of all, a plurality of patterns is recorded in a plurality of data filter units. The data filter units perform a comparing operation on a data stream according its corresponding pattern and output a comparing result respectively. If the space of any one of the data filter units for storing the pattern is not enough to record the required pattern, two or more of the data filter units are combined into an equivalent data filter unit, such that the equivalent data filter unit stores the required pattern to perform the comparing operation.

According to an embodiment of the present invention, the spaces of the data filter units employed for storing the pattern are all n-bytes.

According to an embodiment of the present invention, the data filter units extract service information from the data stream according to the comparing result.

The present invention combines two or more of the data filter units into a structure of an equivalent data filter unit, so as to dynamically adjust the length of filtering data of the decoder. Therefore, the decoder can filter desired information by accurately comparing the pattern of a longer length.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of a PS.

FIG. 1B is a schematic view of TS.

FIG. 2 is an architecture view of a de-multiplexer.

FIG. 3 is a schematic view of a TS.

FIG. 4A is a systematic view of a decoder according to an embodiment of the present invention.

FIG. 4B is a view of an architecture of a decoder 404 in FIG. 4A according to an embodiment of the present invention.

FIG. 4C is a view of an architecture of a decoder 404 in FIG. 4A according to an embodiment of the present invention.

FIG. 5 is a flow chart of an operation method of a decoder according to an embodiment of the present invention.

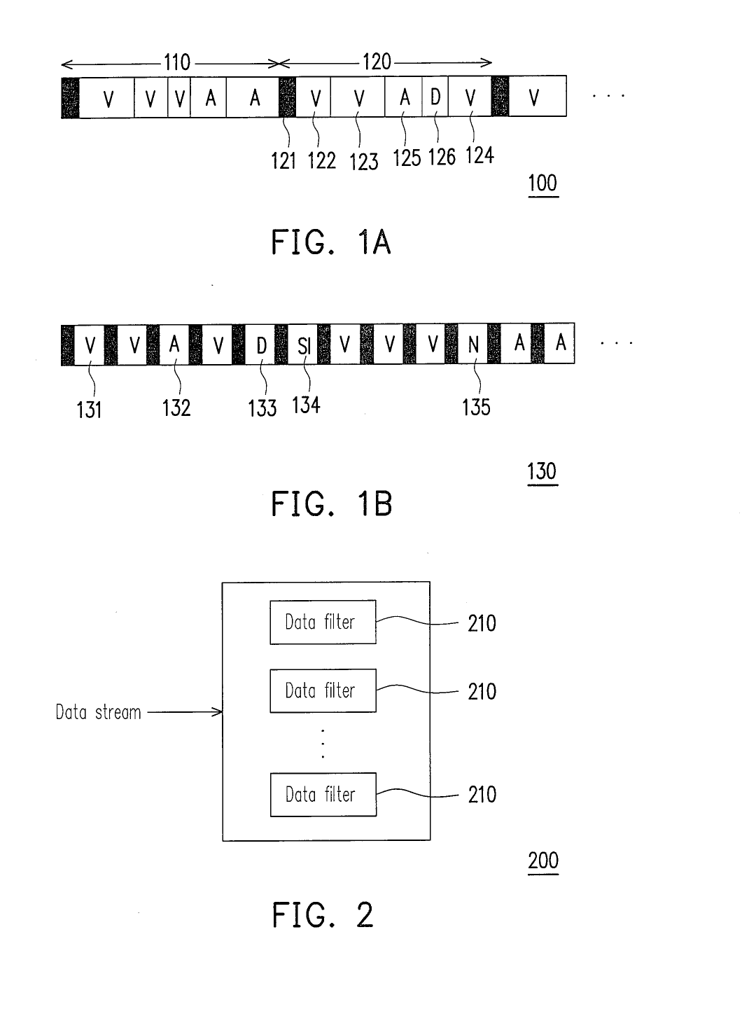

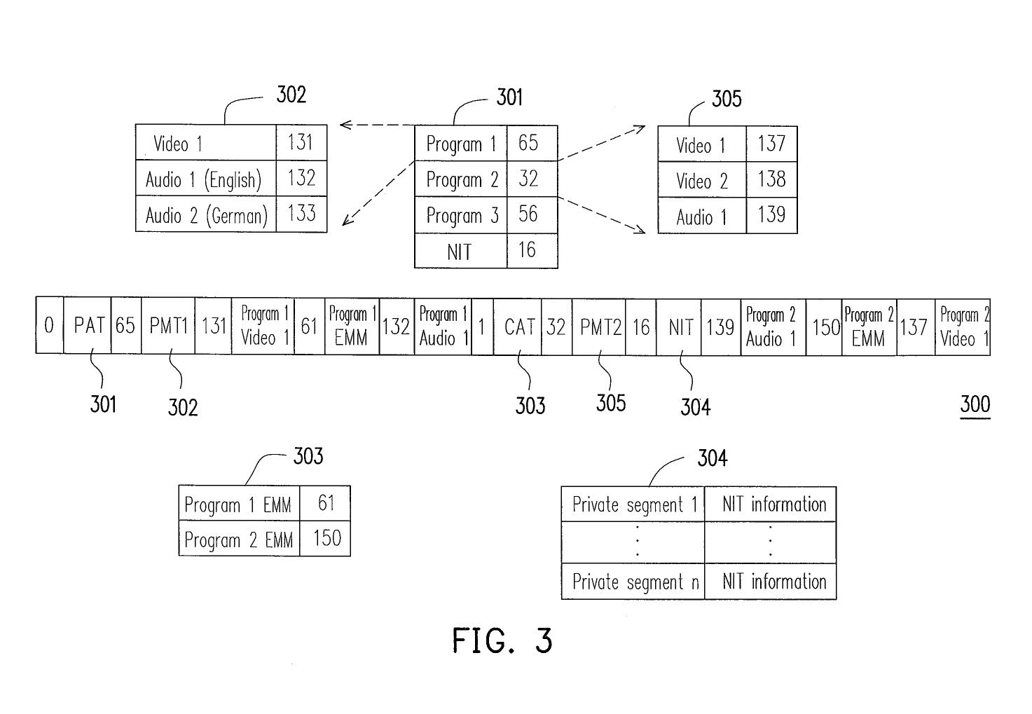

### DESCRIPTION OF EMBODIMENTS

Before illustrating the embodiments of the present invention, first, it is assumed that the decoder of the present invention is used to, but not limited to, filter desired information from a TS, and also can be applied to a data stream in the form of PS and so on.

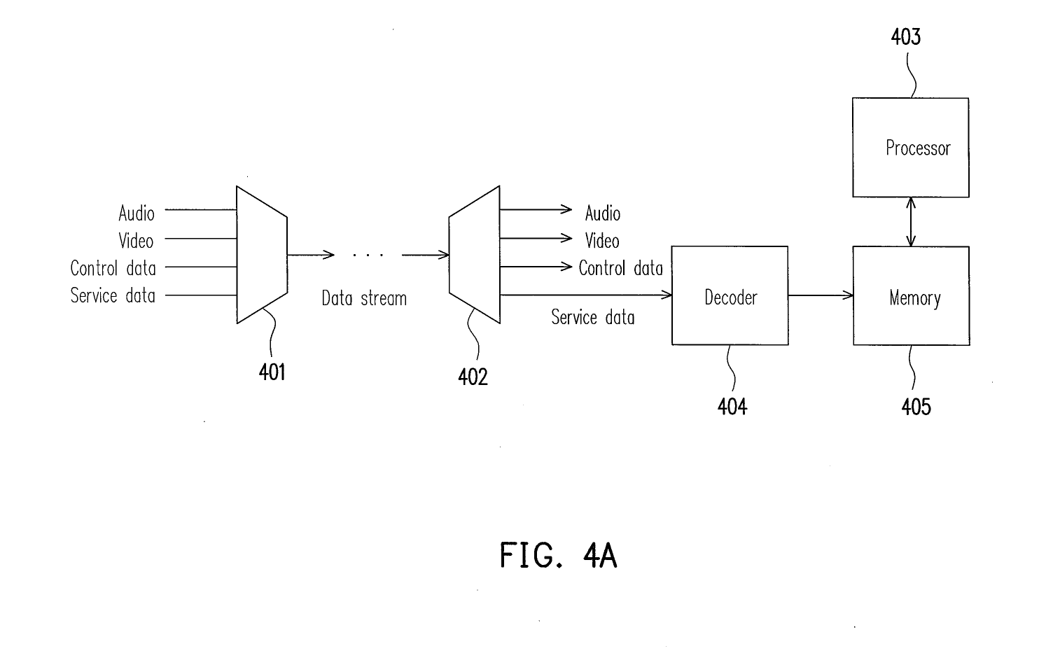

FIG. 3 is a schematic view of a TS. Referring to FIG. 3, a TS 300 includes transport packets of video and audio of each program, and the desired transport packet can be searched merely according to the packet identifier (PID). Generally, the PID is set in a header of the transport packet. Accordingly, in order to acquire the information of a specified program in the TS 300, so-called service information (SI) is defined in MPEG-2 encoding standard.

In digital television (DTV) application, the SI mainly includes a program association table (PAT) 301, a program map table (PMT) 302, a conditional access table (CAT) 303, and a network information table 304. The PAT 301 (PID=0) records the PID of the PMT of each program in the TS 300, for example, the PMT 302 of a program 1 is stored in the transport packet of PID=65, and a PMT 305 of a program 2 is stored in the transport packet of PID=32. Further, the PAT 301 also records the PID of the network information table 304, for example, the network information table 304 is stored in the transport packet of PID=16.

The PMTs 302, 305 are used to get the PIDs of the video and audio of each program. For example, the PMT 302 records a video 1 of the program 1 in the transport packet of PID=131, and an audio 1 (for example, English) and an audio 2 (for example, German) of the program 1 are respectively stored in the transport packets of PID=132, PID=133. The PMT 305 records a video 1 and a video 2 of a program 2 in the transport packets of PID=137, PID=138 and an audio 1 of the program 2 in the transport packet of PID=139.

The network information table 304 is used to identify a plurality of TSs, so as to find the relevant TSs. The CAT 303 (PID=1) records an entitlement management message (EMM) of each program to encrypt the transport packet. The EMM is a private conditional access information, and the private conditional access information specifies the authorization levels or the service of a specific decoder.

It can be known from the above illustration, a large amount of data to be processed is integrated in the TS. In order to reduce the amount of computation and the bandwidth demand, a decoder is required to compare data streams, so as to filter desired information.

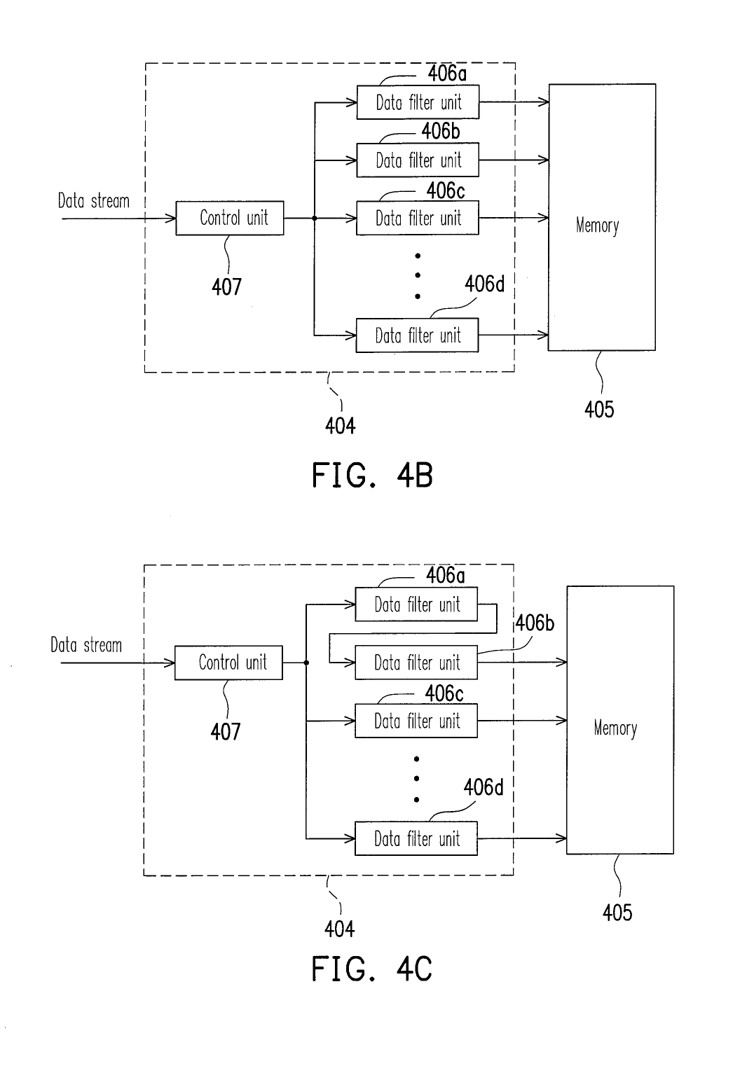

FIG. 4A is a systematic view of a decoder according to an embodiment of the present invention. Referring to FIG. 4A, a multiplexer 401 constructs the audios, the videos, the control data and the SI packet after being encoded and packetized into a data stream, so as to be transported in a channel. A de-multiplexer 402 is correspondingly designed on a receiving end, for decoding the data stream into the audios, the videos, the control data, and the SI packet. As the user of DTV randomly selects programs to watch, the decoder 404 of this embodiment can filter the desired program information, thus it can search out the specified program in time.

In this embodiment, the decoder 404 is used to filter the SI and store the filtered information in a corresponding block in a memory 405. Therefore, a processor 403 can easily search the relevant program information from each block of the memory, for example, the PAT, the PMT, the CAT, and the network information table and process or classify the packets according to the program information. It should be noted that, an example of the decoder 404 of this embodiment filter the SI, but the scope of the present invention is not limited to this, and the decoder can also be used to filter the audios, videos, or the control data.

FIG. 4B is a view of an architecture of a decoder 404 in FIG. 4A according to an embodiment of the present invention. Referring to FIG. 4B, the decoder 404 includes a plurality of data filter units 406a, 406b, 406c and 406d (merely taking 4 data filter units as examples) and a control unit 407. The data filter units 406a, 406b, 406c and 406d perform a comparing operation on a data stream according its corresponding pattern and output a comparing result respectively. The space of each of the data filter units 406a, 406b, 406c and 406d for storing the pattern is n-bytes. In other words, the data filter units 406a, 406b, 406c and 406d can compare the data fragments having fixed lengths (n-bytes) with the pattern.

For example, the data filter units 406a, 406b, 406c and 406d compare the header of the transport packet (or, the PID) with the pattern. If the comparing result of the pattern recorded in a certain data filter unit (for example, the data filter unit 406c) matches the header of the transport packet in the data stream (or, the PID), the data filter unit (for example, the data filter unit 406c) extracts this data fragment (for example, the SI) according to the comparing result and records the data fragment in the corresponding block of the memory 405.

FIG. 4C is an architecture view of a decoder 404 in FIG. 4A according to an embodiment of the present invention. Referring to FIG. 4C, generally, the number of the data filter units is designed according to the maximal requirement of the system, for example, the maximal required number of the system is M. However, under normal circumstances, the M data filter units do not perform filtering process simultaneously. In order to make the data filter units to compare the data fragments more accurately, it is necessary to increase the length of the required pattern. At this time, the control unit 407 controls the configurations of the data filter units, such that the length of the required pattern will not be limited by the fixed length (n-bytes) of the data filter units. In other words, the control unit 407 dynamically adjusts the length of filtering data.

For example, when the space of the data filter unit (for example, data filter unit 406a) for storing the pattern is not enough to record the required pattern, the control unit 407 combines two or more data filter units into an equivalent data filter unit, for example, combines the data filter units 406a and 406b into an equivalent data filter unit of 2n-bytes. Accordingly, the equivalent data filter unit can store the required pattern and perform a comparing operation on a data fragment of a length of at most 2n-bytes. If the comparing result of the pattern stored in such a equivalent data filter unit matches the header of the transport packet (or, the PID) in the data stream, the equivalent data filter unit extracts the data fragment (for example, the SI) according to the comparing result and stores the data fragment in the corresponding block in the memory 405.

Similarly, the control unit 407 can also combine the data filter units 406a, 406b, 406c in to an equivalent data filter unit of 3n-bytes, or combine the data filter units 406a, 406b, 406c and 406d into an equivalent data filter unit of 4n-bytes. Therefore, the decoder 404 not only can dynamically adjust the length of filtering data according to the required pattern, but also can accurately compare the data fragments to filter desired information.

Further, in the embodiments of the present invention, it is assumed that the data filter units 406a, 406b, 406c and 406d all have a fixed length of n-bytes, in another embodiment of the present invention, the data filter units can have a length of different bytes respectively. At this time, the control unit 407 will combine two or more of the data filter units into an equivalent data filter unit according to the required pattern according to the application.

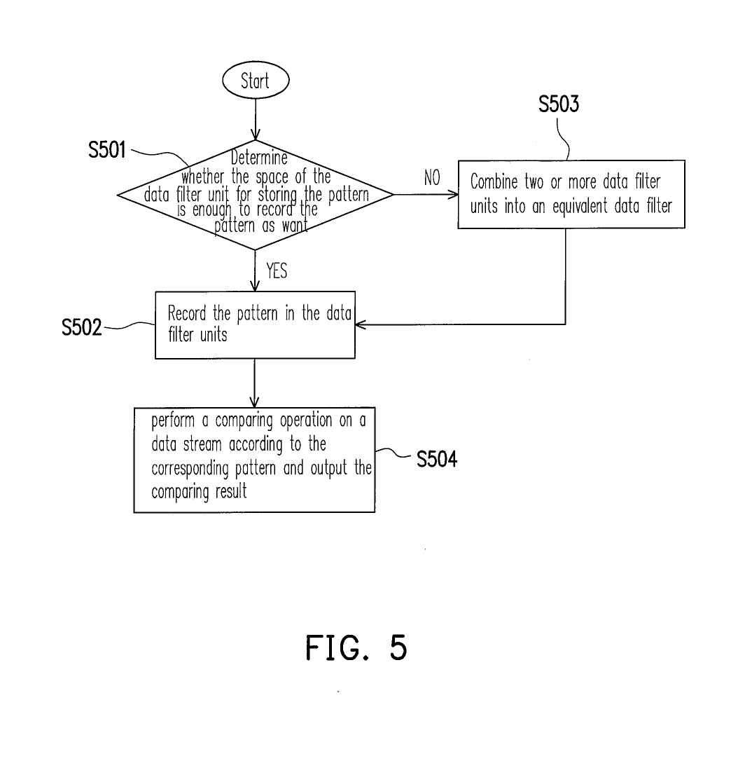

The method flow can be summarized according to the above embodiments as follows herein. FIG. 5 is a flow chart of an operation method of a decoder according to an embodiment of the present invention. Referring to FIG. 5, first of all, whether a space of the data filter unit for storing the pattern is enough to record the required pattern is determined (S501), if yes, the pattern is recorded in the data filter unit (S502). Otherwise, two or more data filter units are combined into an equivalent data filter unit (S503), and the pattern is recorded in the equivalent data filter unit (S502). Next, the data filter unit (or the equivalent data filter unit) performs a comparing operation on a data stream according its corresponding pattern and outputs the comparing result (S504).

In view of above, the decoder according to the embodiment of the present invention can not only dynamically adjust the length of filtering data according to the size of the required pattern, but also can perform more accurate comparison with a pattern having a longer length to filter desired information. The flexible length decoder can be applied to the filtering process of any data stream.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decoder, comprising:
a plurality of data filter units, respectively for performing a comparing operation on a data stream according to its corresponding pattern and outputting a comparing result; and
a control unit, for controlling configurations of the data filter units, wherein if a space of any one of the data filter units for storing the pattern is not enough to record a required pattern, the control unit combines two or more of the data filter units into an equivalent data filter unit, such that the equivalent data filter unit stores the required pattern and performs the comparing operation.

2. The decoder as claimed in claim 1, wherein spaces of the data filter units for storing the pattern are all n-bytes.

3. The decoder as claimed in claim 1, wherein service information (SI) is extracted from the data stream according to the comparing results.

4. The decoder as claimed in claim 3, wherein the SI comprises a program association table (PAT), a program map table (PMT), a conditional access table (CAT), and a network information table.

5. An operation method of a decoder, comprising:
recording a plurality of pattern in a plurality of data filter units;
respectively performing a comparing operation on a data stream according its corresponding pattern and outputting a comparing result using the data filter units; and
combining two or more of the data filter units to form an equivalent data filter unit when a space of any one of the data filter units for storing the pattern is not sufficient to record a required pattern such that the equivalent data filter unit stores the required pattern to perform the comparing operation.

6. The operation method of a decode as claimed in claim 5, wherein spaces of the data filter units for storing the pattern are all n-bytes.

7. The operation method of a decode as claimed in claim 5, further comprising a step of extracting SI from the data stream according to the comparing results.

8. The operation method of a decode as claimed in claim 7, wherein the service information comprises a PAT, a PMT, a CAT, and a network information table.
